(19) United States
(12) Patent Application Publication
(10) Pub. No.: US 2017/0131561 A1
(43) Pub. Date: May 11, 2017

(54) CAMERA MODULE HAVING OPTICAL IMAGE STABILIZER FUNCTION

(71) Applicant: THE ONE CO., LTD., Hwaseong-si, Gyeonggi-do (KR)

(72) Inventor: Hyunjoo JUNG, Suwon-si, Gyeonggi-do (KR)

(73) Assignee: THE ONE CO., LTD., Hwaseong-si, Gyeonggi-do (KR)

(21) Appl. No.: 15/127,418

(22) PCT Filed: Mar. 27, 2015
(86) PCT No.: PCT/KR2015/003075

§ 371 Date: Sep. 20, 2016

(30) Foreign Application Priority Data
Mar. 27, 2014 (KR) 10-2014-0036255
Mar. 27, 2014 (KR) 10-2014-0036260
Nov. 25, 2014 (KR) 10-2014-0165346

(51) Int. Cl. G02B 27/64

(52) U.S. Cl. CPC G02B 27/646

(57) ABSTRACT

The present invention relates to a camera module having an optical image stabilizer (OIS) function and, particularly, to a slim-shaped camera module, having an optical image stabilizer function, capable of minimizing the whole thickness of the camera module while correcting shake by a swing drive method through a rotational vibration movement. The camera module having an optical image stabilizer function, according to the present invention, comprises: an optical module comprising at least one lens and an image sensor provided at the lower section of the lens; a hinge member which is received and mounted on the inside of the optical module; a body member which surrounds the hinge member in a state of being spaced apart from the hinge member at a predetermined distance; a hinge part which is formed on the side surface of the hinge member to thus connect the hinge member and the body member and which is formed of a material having elasticity so as to be rotationally vibrated; and a first drive part for rotationally vibrating the hinge member on the basis of the hinge part.

### TECHNICAL FIELD

The present invention relates to a camera module having an optical image stabilizer (OIS) function, and more particularly, to a camera module having an OIS function with a slimmed shape of an overall minimized thickness while correcting shake using a swing driving METHOD VIA ROTATION-VIBRATION MOTION.

### BACKGROUND ART

A camera module has been widely employed by a mobile device such as a portable phone, a smartphone, and a tablet personal computer (PC), front and rear cameras of a vehicle, an event data recorder (EDR) for a vehicle, a camera for sports, and so on.

Such a camera module includes an optical module including an image sensor (an imaging device). In this regard, an optical module may be shaken due to external shake such as user's hand shake or vehicle shake during image or video capture and an object is not capable of being clearly photographed due to shake of the optical module, thereby degrading the quality of the captured image or video.

Recently, in order to overcome this problem, research has been actively conducted into a camera module having an optical image stabilizer (OIS) function and smartphones having the OIS function are currently manufactured and sold.

One of conventional shake correction methods is a shift driving method of correcting shake of an optical module through linear motion of X and Y axes corresponding to perpendicular coordinates on a plane positioned in parallel to an imaging surface of an image sensor. However, in reality, the optical module of the camera module is not always shaken only in a plane and, thus, there is a limit in correcting shake through only two-dimensional linear motion such as the shift driving method.

Another one of the conventional shake correction methods is a swing driving method of correcting shake of an optical module through rotation-vibration. As a conventional technology of shake correction via the swing driving method, Korean Patent Publication No. 2011-0050210 discloses “shake correction module and camera module including the same”.

The conventional technology is configured to correct shake via swing-driving an optical module based on two axes. In detail, a hinge member includes an upper body, an intermediate body, and a lower body, the upper body and the intermediate body are hinged by a first hinge pair disposed in an x-axis direction, and the intermediate body and the lower body are hinged by a second hinge pair disposed in a y-axis direction and, thus, the optical module swings based on two axes, that is, the first pair and the second hinge pair, thereby correcting shake.

However, according to the conventional technology with the aforementioned configuration, a structure including the intermediate body, the lower body, the first hinge pair, and the second hinge pair is disposed below the optical module and, thus, a thickness of an entire module may be increased. Accordingly, there is a limit in applying a camera module according to the prior art to a mobile device such as a smartphone that has been gradually miniaturized and slimmed. In reality, an OIS function applied to a smartphone with an OIS function, which is currently sold on the market is a shift driving method but not a swing driving method and, thus, there is a limit in enhancing image quality via shake correction.

### DISCLOSURE

### Technical Problem

An object of the present invention devised to solve the problem lies on a camera module having an optical image stabilizer (OIS) function with a slimmed shape of an overall minimized thickness while correcting shake using a swing driving method via rotation-vibration motion.

### Technical Solution

The object of the present invention can be achieved by providing a camera module having an optical image stabilizer (OIS) function, the camera module including an optical module including at least one lens and an image sensor disposed below the lens, a hinge member for accommodating the optical module therein so as to fixedly install the optical module, a body member disposed to surround the hinge member so as to be spaced apart from the hinge member by a predetermined interval, a hinge portion formed at a lateral surface of the hinge member so as to connect the hinge member and the body member and formed of an elastic material so as to be rotation-vibrated, and a first driver for rotation-vibrating the hinge member based on the hinge portion with respect to the body member.

In addition, the hinge portion may be disposed on one lateral surface of the hinge member, and a support for supporting the rotation-vibrated hinge member with respect to one hinge portion is disposed at another lateral surface of the one hinge member, which faces the lateral surface.

### Advantageous Effects

According to embodiments of the present invention, a camera module having an optical image stabilizer (OIS) function may precisely correct shake using a swing driving method via rotation-vibration, thereby acquiring an image with a high image quality.

According to embodiments of the present invention, the camera module having an OIS function may have an overall minimized thickness because a hinge portion configured to rotation-vibrate is formed on a lateral surface of a hinge member and, thus, may be applied to a slimmed smartphone.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

FIG. 1 is a cross-sectional view of a camera module with an optical image stabilizer (OIS) function according to an exemplary embodiment of the present invention.

FIG. 2 is an exploded perspective view of the camera module of FIG. 1.

FIG. 3 is a cross-sectional view of an optical module according to an exemplary embodiment of the present invention.

FIG. 4 is an enlarged view of a portion ‘A’ of FIG. 1.

FIG. 5 is a perspective view illustrating a hinge portion illustrated in FIG. 4.

FIGS. 6 to 8 are diagrams for explanation of various exemplary embodiments of the present invention of a hinge portion.

FIG. 9 is a cross-sectional view of a camera module having an OIS function according to another exemplary embodiment of the present invention.

FIG. 10 is an exploded perspective view of the camera module of FIG. 9.

FIG. 11 is a perspective view of a hinge member illustrated in FIG. 10.

FIG. 12 is a cross-sectional view of a camera module having an OIS function according to another exemplary embodiment of the present invention.

FIG. 13 is an exploded perspective view of the camera module of FIG. 12.

### BEST MODE

Hereinafter, exemplary embodiments of the present invention will be described in detail by explaining exemplary embodiments of the invention with reference to the attached drawings.

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

Relative terms, such as “before” and “after”, “right” and “left”, “upper” and “lower”, and “lateral side” may be used herein for description of a relationship between elements based on a direction as illustrated in the figures but the present invention is not limited by these terms. In the drawings, the thicknesses of layers and regions are exaggerated for clarity. Accordingly, the present invention is not limited by the relative size and thickness illustrated in the accompanying drawings

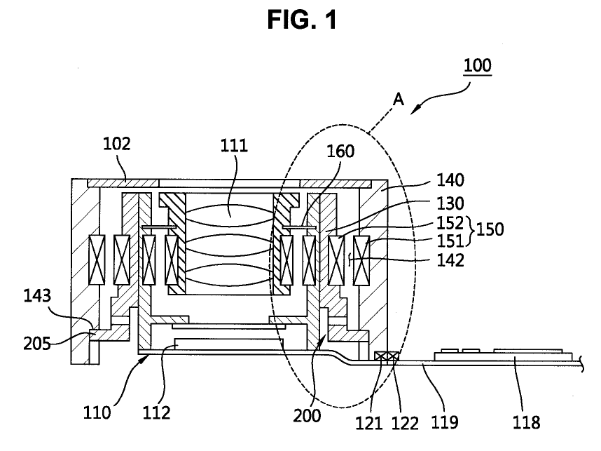

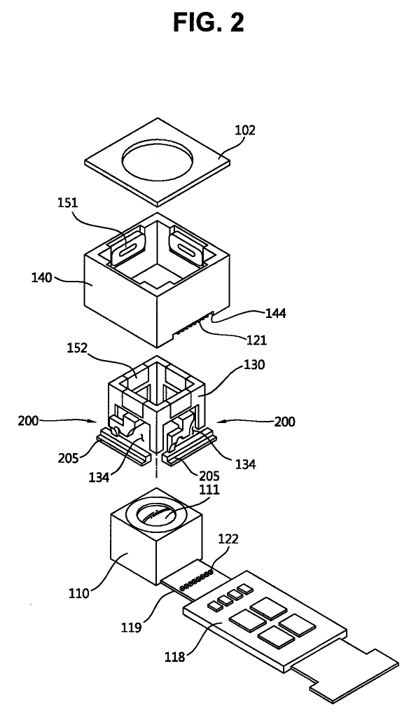

FIG. 1 is a cross-sectional view of a camera module 100 with an optical image stabilizer (OIS) function according to an exemplary embodiment of the present invention and FIG. 2 is an exploded perspective view of the camera module 100 of FIG. 1.

Referring to FIGS. 1 and 2, the camera module 100 according to the present embodiment may include an optical module 110, a hinge member 130, a body member 140, a first driver 150, and a hinge portion 200.

The optical module 110 may include at least one lens 111 and an image sensor 112 disposed below the lens 111, which are included in the optical module 110. The image sensor 112 may be fixedly coupled to an internal portion of the optical module 110 and, thus, may be moved according to movement of the optical module 110.

The optical module 110 may be configured via a combination of one or two or more selected from the group consisting of an optical system with adjustable auto focus (AF), a short focal length optical system, a dual optical system for simultaneously embodying a short focal length optical system and a zoom optical system, and a zoom optical system. The present invention may not be limited to the detailed configuration of the optical module 110.

The hinge member 130 may accommodate the optical module 110 therein so as to fixedly install the optical module 110 and the body member 140 may be disposed to surround the hinge member 130 so as to be spaced apart from the hinge member 130 by a predetermined interval 142. The camera module 100 may further include a cover 102 that is coupled to an upper portion of the body member 140 to prevent separation of the optical module 110 installed in the hinge member 130.

The hinge portion 200 may be formed at a lateral surface of the hinge member 130 so as to connect the hinge member 130 and the body member 140 and may be formed of an elastic material so as to be rotation-vibrated. Accordingly, the hinge member 130 may be capable of being rotation-vibrated based on the hinge portion 200 with respect to the body member 140. As such, when the hinge member 130 is rotate-vibrated based on the hinge portion 200, the optical module 110 that is accommodated in the hinge member 130 and fixedly installed to the hinge member 130 may also be rotated-vibrated along with the hinge member 130 and, accordingly, shake of the optical module 110 may be corrected via a swing driving method via rotation-vibration, thereby precisely correcting shake of the optical module 110. In particular, since the hinge portion 200 is formed at a lateral surface of the hinge member 130, a thickness (or a height) of the camera module 100 may be minimized.

That is, since the camera module 100 according to the present invention is configured in such a way that the hinge portion 200 for enabling rotation-vibration for shake correction is formed at the lateral surface of the hinge member 130, the thickness of the camera module 100 may be minimized and, accordingly, the camera module 100 may be manufactured with an entirely slim thickness while correcting shake via a swing driving method.

The hinge portion 200 may be formed of an elastic material and may be separately formed from the hinge member 130. In this case, the hinge portion 200 may have one side coupled to the lateral surface of the hinge member 130 and the other side bonded to the body member 140 so as to connect the hinge member 130 and the body member 140 to each other.

The hinge portion 200 may be formed of an elastic material and may be formed with the hinge member 130 as one body via a method such as injection molding. Accordingly, the hinge member 130 may also be formed of an elastic material along with the hinge portion 200. Examples of the elastic material may include rubber, silicon, and plastic, but the present invention is not limited thereto.

The hinge portion 200 may protrude from the lateral surface of the hinge member 130 so as to be integrally formed with the hinge member 130. In this case, the hinge portion 200 may be configured in such a way that an end portion 205 of the hinge portion 200 protruding from the lateral surface of the hinge member 130 is coupled to the body member 140 so as to connect the hinge member 130 and the body member 140 to each other. For example, a fixing projection 143 may be formed at one side of an internal surface of the body member 140 and the end portion 205 of the hinge portion 200 may be shaped like a fixing hook stumbled by the fixing projection 143. In this regard, as the end portion 205 shaped like a fixing hook is bonded to the fixing projection 143 of the body member 140 while being stumbled by the fixing projection 143, the hinge member 130 and the body member 140 may be connected.

The first driver 150 may be a component for rotation-vibrating the hinge member 130 based on the hinge portion 200 with respect to the body member 140 and may include a first coil 151 and a first magnet 152 that are respectively disposed on an external lateral surface of the hinge member 130 and an internal lateral surface of the body member 140 so as to face each other, and an electrical signal for an optical image stabilizer (OIS) may be applied to the first coil 151.

Hereinafter, components of the camera module 100 according to the present embodiment will be described in detail.

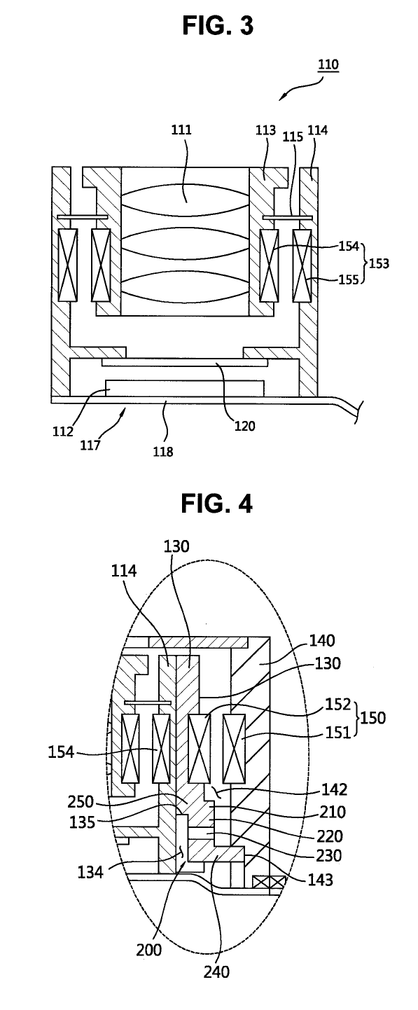

First, as an exemplary embodiment of the optical module 110, the optical module 110 including an optical system with adjustable auto focus (AF) will be described in detail with reference to FIG. 3.

Referring to FIG. 3, the optical module 110 including an optical system with adjustable AF according to an exemplary embodiment of the present invention may include a lens holder 113 including at least one lens 111, a base member 114 that surrounds the lens holder 113 while being spaced apart from the lens holder 113 by a predetermined interval, an elastic member 115 for connection between the lens holder 113 and the base member 114, a sensor module 116 including the image sensor 112 and coupled to a lower portion of the base member 114, and a second driver 153 for driving the lens holder 113 with respect to the base member 114.

Referring to FIGS. 2 and 3, the sensor module 116 may include a sensor circuit board 117 to which the image sensor 112 is bonded, a control circuit board 118 to which the sensor circuit board 117 is connected, a flexible circuit board 119 for connection between the sensor circuit board 117 and the control circuit board 118, and an IR cut filter 120 disposed above the image sensor 112.

When the hinge member 130 accommodates the optical module 110 that has the aforementioned configuration with adjustable AF so as to fixedly install the optical module 110, the hinge member 130 may be bonded to the base member 114. According to another exemplary embodiment of the present invention, the hinge member 130 may be integrally formed with the base member 114. In this case, as described above, the hinge member 130 may be formed of an elastic material and may be integrally formed with the hinge portion 200 using a method such as injection molding and, thus, the base member 114 may also be formed of an elastic material and may be integrally formed with the hinge member 130 and the hinge portion 200.

The second driver 153 may include a second coil 154 and a second magnet 155 that are respectively disposed on an external lateral surface of the lens holder 113 and an internal lateral surface of the base member 114 so as to face each other, and an electrical signal for an auto focus (AF) may be applied to the second coil 154.

That is, when the camera module 100 according to an exemplary embodiment of the present invention is configured to correct shake of the optical module 110 with an auto focus (AF) function, an electrical signal for shake correction may be applied to the first coil 151 of the first driver 150 and an electrical signal for AF adjustment may be applied to the second coil 154 of the second driver 153.

Referring to FIG. 2, the hinge member 130 may have an approximately rectangular section and include the first magnet 152 disposed at an upper portion of the lateral surface of the hinge member 130 and the hinge portion 200 disposed at a lower portion of the hinge portion 200. However, the hinge member 130 may have a circular section other than a rectangular section and the present invention may not be limited by a sectional shape of the hinge member 130.

A lateral groove 134 may be formed below the lateral surface of the hinge member 130 so as to easily form the hinge portion 200 and to enable smooth rotation-vibration of the hinge portion 200, and the hinge portion 200 may be disposed at the lateral surface of the hinge member 130 in various forms for smooth rotation-vibration, which will be described below in detail.

The body member 140 may have an approximately rectangular section like the hinge member 130 so as to surround the hinge member 130 while being spaced apart from the hinge member 130 by the predetermined interval 142 and may include the first coil 151 that is disposed at each lateral surface so as to face the first magnet 152. Like the hinge member 130, the body member 140 may have a circular section other than a rectangular section and the present invention may not be limited by a sectional shape of the body member 140.

An opening 144 for insertion of the flexible circuit board 119 may be formed below the body member 140 so as to electrically connect the first coil 151 and the second coil 154 to the flexible circuit board 119. The opening 144 may include a first coil connection terminal 121 that is electrically connected to lead wires (not shown) that are connected to the first coil 151 and the second coil 154, respectively, and the flexible circuit board 119 passing through the opening 144 may include a second coil connection terminal 122 disposed at a predetermined portion of the flexible circuit board 119 so as to be electrically connected to the first coil connection terminal 121.

In the present embodiment, the first coil 151 and the second coil 154 are disposed on the internal lateral surface of the body member 140 and the internal lateral surface of the base member 114, respectively, and the first magnet 152 and the second magnet 155 may be disposed on the external lateral surface of the hinge member 130 and the external lateral surface of the lens holder 113, respectively, but the present invention is not limited thereto and, accordingly, the first coil 151 and the second coil 154 may be disposed on the external lateral surface of the hinge member 130 and the external lateral surface of the lens holder 113, respectively, and the first magnet 152 and the second magnet 155 may be disposed on the internal lateral surface of the body member 140 and the internal lateral surface of the lens holder 113, respectively.

As described above, the opening 144 for insertion of the flexible circuit board 119 may be formed at one side of the body member 140. In this regard, as illustrated in FIG. 2, when the body member 140 and the hinge member 130 each have an approximately rectangular section, the opening 144 may be formed at any one of four lateral surfaces of the body member 140. However, as such, when the body member 140 and the hinge member 130 each have an approximately rectangular section and the opening 144 is formed at any one of the four lateral surfaces of the body member 140, the flexible circuit board 119 may be inserted into the lateral surface of the body member 140 having the opening 144 formed therein through the opening 144 and, thus, it may not be easy to dispose the hinge portion 200 on a lateral surface of the hinge member 130, which faces the lateral surface of the body member 140 in which the opening 144 is formed and, in this case, two hinge portions 200 may be disposed at lateral surfaces facing two opposite surfaces of the body member 140, in which the opening 144 is not formed, among the four lateral surfaces of the hinge member 130. That is, although FIG. 2 illustrates an exemplary embodiment in which four hinge portions 200 are disposed on the four lateral surfaces of the hinge member 130 having an approximately rectangular section, the present invention is not limited thereto and, thus, the two hinge portions 200 may be disposed on two opposite lateral surfaces among the four lateral surfaces of the hinge member 130, and the two opposite lateral surfaces of the hinge member 130, on which the hinge portions 200 are disposed, may face the two lateral surfaces, in which the opening 144 of the body member 140 for insertion of the flexible circuit board 119 is not formed.

With regard to the camera module 100 having the aforementioned configuration according to the present embodiment, when an electrical signal for shake correction is applied to the first coil 151 from the control circuit board 118, the hinge member 130 may rotation-vibrated by the first driver 150 based on the hinge portion 200 with respect to the body member 140 so as to correct shake of the optical module 110 that is fixedly installed in the hinge member 130, and when an electrical signal for AF adjustment is applied to the second coil 154 from the control circuit board 118, the lens holder 113 may be driven by the second driver 153 so as to adjust a focal point between the lens 111 and the image sensor 112 in the optical module 110.

Since the camera module 100 according to the present embodiment corrects shake while rotation-vibrating the optical module 110, a focal length between the lens 111 and the image sensor 112 in the optical module 110 is not completely affected by shake correction, thereby completely preventing the focal point from being changed due to shake correction.

Hereinafter, various exemplary embodiments of the present invention for the hinge portion 200 will be described in detail with reference to the accompanying drawings.

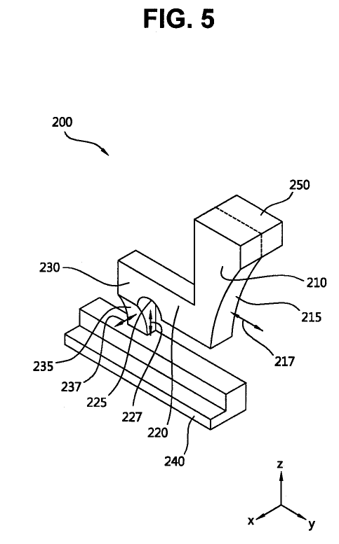

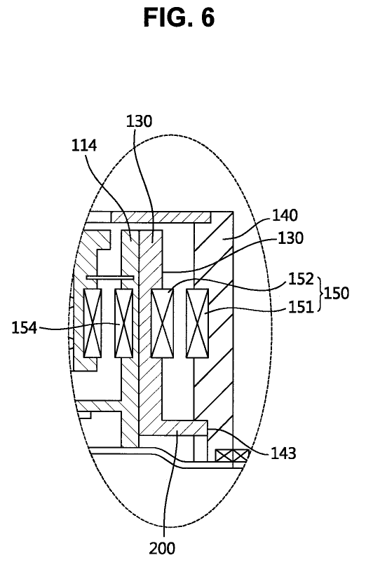

FIG. 4 is an enlarged view of a portion ‘A’ of FIG. 1. FIG. 5 is a perspective view illustrating the hinge portion 200 illustrated in FIG. 4. FIGS. 6 to 8 are diagrams for explanation of various exemplary embodiments of the present invention of a hinge portion.

First, referring to FIG. 6, the hinge portion 200 according to an exemplary embodiment of the present invention may be configured in the form of a single axis. Since the hinge portion 200 is formed of an elastic material so as to be autonomously rotation-vibrated, when the hinge member 130 and the body member 140 are connected to each other by the hinge portion 200 configured in the form of a single axis, the hinge member 130 may be rotation-vibrated based on the hinge portion 200 with respect to the body member 140.

The hinge portion 200 may be configured to be rotation-vibrated based on three axes so as to enable smooth rotation-vibration motion. In this regard, the case in which the hinge portion 200 is capable of being rotation-vibrated based on three axes is illustrated in FIGS. 4 and 5.

Referring to FIGS. 4 and 5, the hinge portion 200 as an exemplary embodiment for enabling rotation-vibration motion based on three axes may include a first hinge portion 210 connected to the lateral surface of the hinge member 130 and extending in a lower direction, a second hinge portion 220 bent and extending from the first hinge portion 210, a third hinge portion 230 bent and extending in a lower direction from the second hinge portion 220, and a coupler 240 connected to the third hinge portion 230 and coupled to the body member 140. Here, the coupler 240 may be a component corresponding to the aforementioned end portion 205 of the hinge portion 200 and, accordingly, as described above, the coupler 240 may be shaped like a stumbling hook stumbled by a stumbling projection 143 of the body member 140.

The second hinge portion 220 may be bent and extend in a front or rear direction from the first hinge portion 210 and the coupler 240 may extend in a lateral direction from the third hinge portion 230 so as to be coupled to the internal lateral surface of the body member 140. Here, the lateral direction is a direction toward the body member 140 from the hinge member 130 and is indicated by an x axis in FIG. 4, the front or rear direction is a direction approximately perpendicular to the lateral direction and is indicated by a y axis in FIG. 4, and the lower direction is a direction approximately perpendicular to the lateral direction and the front and rear directions and is indicated by a z axis in FIG. 4.

Accordingly, the hinge portion 200 is capable of being rotation-vibrated based on the first hinge portion 210, the second hinge portion 220, and the third hinge portion 230, that is, three axes so as to enable smooth rotation-vibration and, also, the first hinge portion 210, the second hinge portion 220 and the third hinge portion 230 are formed on a y-z plane positioned approximately parallel to the lateral surface of the hinge member 130 and, thus, may be easily formed in a narrow interval 142 between the hinge member 130 and the body member 140.

The interval 142 between the hinge member 130 and the body member 140 may be formed to be narrow so as to facilitate smooth driving by the first coil 151 and the first magnet 152 that are disposed on the external lateral surface of the hinge member 130 and the internal lateral surface of the body member 140 and, thus, the hinge portion 200 protruding from the lateral surface of the hinge member 130 needs to be formed in the narrow interval 142, which may be achieved by extending the first hinge portion 210 in a lower direction, by bending and extending the second hinge portion 220 from the first hinge portion 210 in a front or rear direction, and by bending and extending the third hinge portion 230 from the second hinge portion 220 in a lower direction.

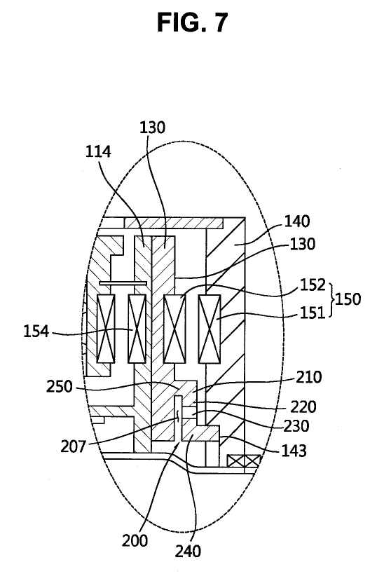

As illustrated in FIG. 7, the hinge portion 200 may further include a protrusion 250 protruding from the lateral surface of the hinge member 130 and the first hinge portion 210 may be bent and extend from the protrusion 250 in a lower direction. In order to facilitate smooth rotation-vibration of the hinge portion 200, the first hinge portion 210, the second hinge portion 220, and the third hinge portion 230 need to be spaced apart from the lateral surface of the hinge member 130 by a predetermined interval 207, which may be achieved by the protrusion 250.

As illustrated in FIGS. 1, 2, 4, 5, and 8, the lateral groove 134 may be formed below the lateral surface of the hinge member 130 and the first hinge portion 210 may extend from an upper end 135 of the lateral groove 134 in a lower direction.

As illustrated in FIG. 7, when the hinge portion 200 includes the protrusion 250, it may not be easy to dispose the hinge portion 200 in the narrow interval 142 between the hinge member 130 and the body member 140, but when the lateral groove 134 is formed below the lateral surface of the hinge member 130 and the first hinge portion 210 is formed at the upper end 135 of the lateral groove 134, it may be easier to dispose the hinge portion 200 in the interval 142 and smooth rotation-vibration motion of the hinge portion 200 may also be enabled by a space formed by the lateral groove 134.

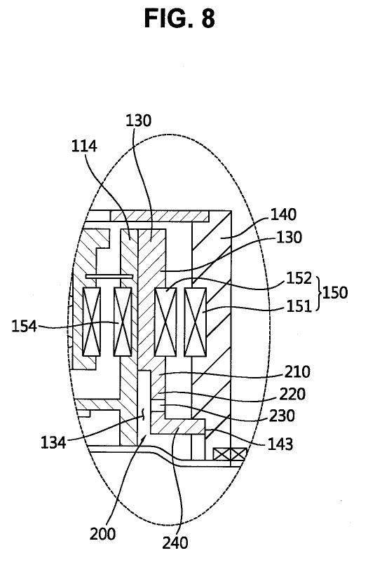

As illustrated in FIG. 8, the first hinge portion 210 may extend from the upper end 135 of the lateral groove 134 in a lower direction without protruding from the lateral surface of the hinge member 130, but as illustrated in FIGS. 1, 2, 4, and 5, the first hinge portion 210 may extend in a lower direction while protruding from the lateral surface of the hinge member 130. For example, as illustrated in FIG. 4, the protrusion 250 is formed at the upper end 135 of the lateral groove 134 such that one side of the protrusion 250 protrudes from the lateral surface of the hinge member 130 within a permissible range of the narrow interval 142, and the first hinge portion 210 may be bent and extend from one side of the protrusion 250 in a lower direction. Accordingly, the first hinge portion 210 may extend in a lower direction while protruding from the lateral surface of the hinge member 130 within a permissible range of the narrow interval 142 and, as such, when the first hinge portion 210 extends in a lower direction from the lateral surface of the hinge member 130, the hinge portion 200 may be more smoothly rotation-vibrated.

First, second, and third width reduction grooves 215, 225, and 235 for smooth rotation-vibration may be formed in at least one of the first hinge portion 210, the second hinge portion 220, and the third hinge portion 230. Accordingly, smoother rotation-vibration may be enabled while the first hinge portion 210 is based on the first width reduction groove 215, the second hinge portion 220 is based on the second width reduction groove 225, and the third hinge portion 230 is based on the third width reduction groove 235.

In this case, a groove forming direction 217 of the first width reduction groove 215 formed at the first hinge portion 210 and a groove forming direction 237 of the third width reduction groove 235 formed at the third hinge portion 230 may be different and, for example, the groove forming directions 217 and 237 of the first width reduction groove 215 and the third width reduction groove 235 may be approximately perpendicular to each other.

Since the first hinge portion 210 and the third hinge portion 230 extend downward to be perpendicular to each other, rotation-vibrations of the first hinge portion 210 and the third hinge portion 230 may be performed in different directions, which may be enabled by differently determining the groove forming direction 217 of the first width reduction groove 215 and the groove forming direction 237 of the third width reduction groove 235.

For example, as illustrated in FIG. 5, when the groove forming direction 217 of the first width reduction groove 215 is an approximate y-axis direction, the first hinge portion 210 may rotation-vibrate in an approximate y-axis direction (or frontward and backward) based on the x-axis, and when the groove forming direction 237 of the third width reduction groove 235 is an approximate x-axis direction, the third hinge portion 230 may rotation-vibrate in an approximate x-axis direction (or right and left directions) based on the y-axis.

The second width reduction groove 225 may also be different from the first width reduction groove 215 and the third width reduction groove 235 and, for example, the first width reduction groove 215 and the third width reduction groove 235 may be approximately perpendicular to each other.

For example, as illustrated in FIG. 5, when a groove forming direction 227 of the second width reduction groove 225 is an approximate z-axis direction, the second hinge portion 220 may rotate-vibrate in an approximate z-axis direction (or upward and downward) based on the x-y plane.

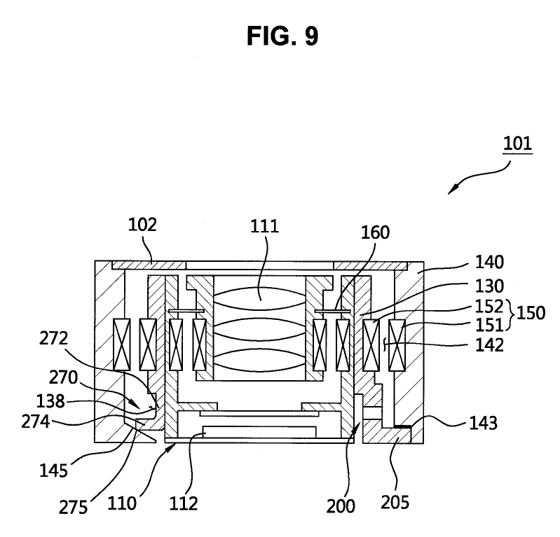

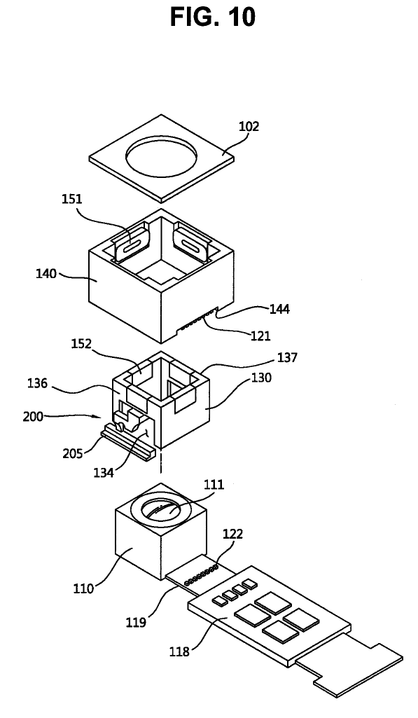

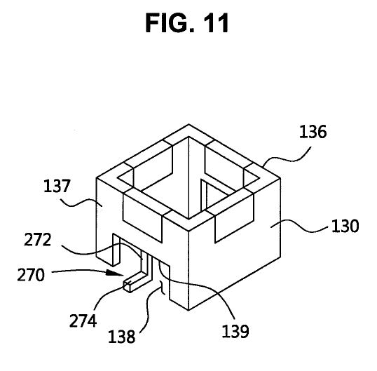

FIG. 9 is a cross-sectional view of a camera module having an OIS function according to another exemplary embodiment of the present invention. FIG. 10 is an exploded perspective view of the camera module of FIG. 9. FIG. 11 is a perspective view of a hinge member illustrated in FIG. 10.

Referring to FIGS. 9 to 11, a camera module 101 according to the present embodiment may include one hinge portion 200 disposed on any one lateral surface 136 of the hinge member 130 and a support 270 for supporting rotation-vibration of the hinge member 130.

As described above with regard to the above embodiment, when the hinge member 130 has a rectangular section and the hinge portions 200 are disposed on all of four lateral surfaces or two opposite lateral surfaces, rotation-vibration based on the hinge portions 200 may be offset and, thus, smooth rotation-vibration may not be performed during shake correction.

In order to prevent the above problem, the camera module 101 according to the present embodiment may be configured in such a way that the hinge portion 200 is disposed on any one lateral surface 136 of the hinge member 130, and, as such, when one hinge portion 200 is disposed on any one lateral surface 136 of the hinge member 130, the camera module 101 includes the support 270 for stable and smooth rotation-vibration.

That is, the hinge portion 200 according to the present embodiment is basically the same as the hinge portion 200 according to the above embodiment except that one hinge portion 200 is disposed on one lateral surface 136 of the hinge member 130 and, thus, for a detailed description of the hinge portion 200, refer to the above description and, hereinafter, the support 270 will be described in detail.

The support 270 may protrude from another lateral surface 137 facing any one lateral surface 136 on which the hinge portion 200 is disposed and contact the body member 140 so as to support the rotation-vibrated hinge member 130. That is, unlike in a case in which the hinge portion 200 is bonded to the body member 140, the support 270 may support the hinge member 130 to stably and smoothly rotation-vibrate based on the hinge portion 200 while contacting the body member 140.

The support 270 may be formed of an elastic material so as to elastically move according to the rotation-vibration of the hinge member 130 while contacting the body member 140, may be formed of an elastic material, and may be formed with the hinge member 130 as one body via a method such as injection molding, like the hinge portion 200. Accordingly, the hinge member 130, the hinge portion 200, and the support 270 may be formed of an elastic material and may be formed as one body via a method such as injection molding.

The support 270 may be integrally formed with the hinge member 130 while protruding on a lateral surface of the hinge member 130, a lateral groove 138 may be disposed below the lateral surface 137 facing the lateral surface 136 of the hinge member 130, on which the hinge portion 200 is disposed, and the support 270 may include an extension portion 272 that extends downward from an upper end 139 of the lateral groove 138 and a contact portion 274 that externally protrudes from the extension portion 272 and contacts the body member 140.

An end portion 275 of the contact portion 274 may have a circular shape and an inclination surface 145 that is inclined inward for enabling elastic movement while contacting the end portion 275 of the contact portion 274 may be disposed at a lower portion of the body member 140. Accordingly, the support 270 may elastically move while the end portion 275 of the contact portion 274 with a circular shape is contact-supported by the inclination surface 145 of the body member 140 so as to smoothly support rotation-vibration of the hinge member 130.

As described above with regard to the above embodiment, the two opposite lateral surfaces 136 and 137 of the hinge member 130 including the hinge portion 200 and the support 270 according to the present embodiment may be two lateral surfaces in which the opening 144 of the body member 140 for insertion of the flexible circuit board 119 is not formed.

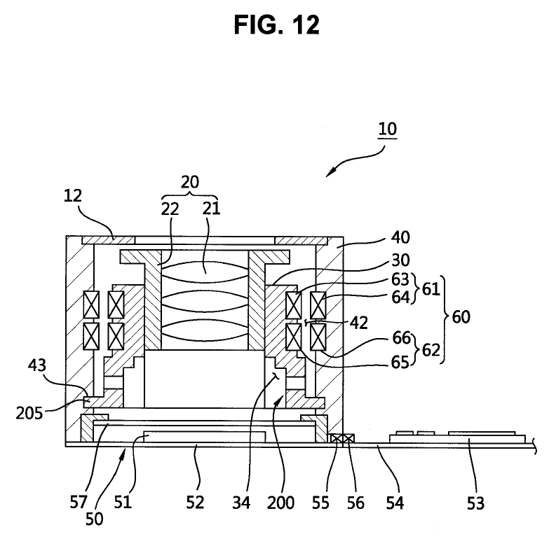

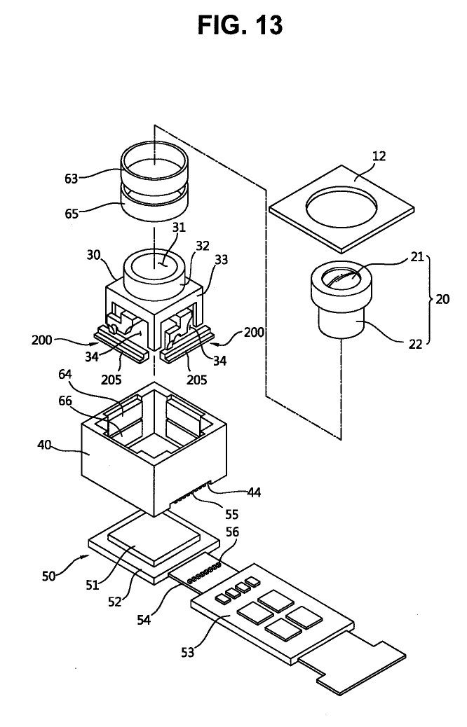

FIG. 12 is a cross-sectional view of a camera module having an OIS function according to another exemplary embodiment of the present invention. FIG. 13 is an exploded perspective view of the camera module of FIG. 12.

Referring to FIGS. 12 and 13, a camera module 10 according to the present embodiment may include a lens module 20, a hinge member 30, a body member 40, a sensor module 50 including an image sensor 51, a driver 60, and a hinge portion 200.

The hinge portion 200 according to the present embodiment is basically the same as the hinge portion 200 according to the above embodiments and, thus, for a detailed description of the hinge portion 200, refer to the above description of the above embodiments. Although not illustrated, the camera module 10 according to the present embodiment may also further include the support 270 like the camera module 101 illustrated in FIGS. 9 to 11 and, thus, for a detailed description of the support 270, refer to the above description of the above embodiments.

The lens module 20 may further include at least one lens 21 and a lens holder 22 for supporting the lens 21. The lens 21 may allow light emitted from an object to converge or diverge to form an image on the image sensor 51.

The hinge member 30 may accommodate the lens module 20 therein so as to fixedly install the lens module 20 and the body member 40 may be disposed to surround the hinge member 30 so as to be spaced apart from the hinge member 30 by a predetermined interval 42. The camera module 10 may further include a cover 12 that is coupled to an upper portion of the body member 40 to prevent the lens module 20 installed in the hinge member 30 from being separated.

The sensor module 50 may include the image sensor 51 that is coupled to a lower portion of the body member 40 and light incident on the lens 21 reaches. The sensor module 50 may include a sensor circuit board 52 to which the image sensor 51 is bonded, a control circuit board 53 to which the sensor circuit board 52 is connected, a flexible circuit board 54 for connection between the sensor circuit board 52 and the control circuit board 53, and an IR cut filter 57 disposed above the image sensor 51.

The driver 60 may be a component for rotation-vibrating the hinge member 30 based on the hinge portion 200 with respect to the body member 40 and may include a first driver 61 for auto focus (AF) adjustment and a second driver 62 for optical image stabilizer (OIS).

The first driver 61 may include a first coil 63 and a first magnet 64 that are respectively disposed on an external lateral surface of the hinge member 30 and an internal lateral surface of the body member 40 so as to face each other and the second driver 62 may include a second coil 65 and a second magnet 66 that are respectively disposed on an external lateral surface of the hinge member 30 and an internal lateral surface of the body member 40 so as to face each other separately from the first driver 61. Accordingly, the first driver 61 and the second driver 62 may each allow the hinge member 30 to rotation-vibrate based on the hinge portion 200 with respect to the body member 40.

Accordingly, the camera module 10 according to the present embodiment may have an overall simple structure because the hinge portion 200 that corrects shake of the hinge member 30 via rotation-vibration may also simultaneously perform an AF function.

Hereinafter, a structure of the camera module 10 according to the present embodiment will be described in detail.

The hinge member 30 may include a hollow hole 31 in which the lens module 20 is fixedly installed, an upper body 32 including the first coil 63 and the second coil 65, and a lower body 33 including the hinge portion 200.

The upper body 32 may have an approximate circular section and, accordingly, the first coil 63 and the second coil 65 may have an approximate circular shape and may be arranged on upper and lower portions of an external lateral surface of the upper body 32. The lower body 33 may have an approximate rectangular section and include four hinge portions 200 disposed on respective lateral surfaces. According to another exemplary embodiment of the present invention, the upper body 32 and the lower body 33 may have the same shape, e.g., a circular section or a rectangular shape but the present invention is not limited thereto.

A lateral groove 34 for easily forming the hinge portion 200 and enabling smooth rotation-vibration of the hinge portion 200 may be formed below a lateral surface of the hinge member 30. The hinge portion 200 may be formed in various forms on a lateral surface of the hinge member 30 for smooth rotation-vibration. For a detailed description thereof, refer to the above description of the above embodiments.

The body member 40 may be formed with an approximately rectangular section in order to surround the hinge member 30 while being spaced from the hinge member 30 by a predetermined interval 42 and may include the first magnet 64 facing the first coil 63 and the second magnet 66 facing the second coil 65 at the respective lateral surfaces.

An opening 44 for insertion of the flexible circuit board 54 may be formed below the body member 40 so as to electrically connect the first coil 63 and the second coil 65 to the flexible circuit board 54. The opening 44 may include a first coil connection terminal 55 that is electrically connected to a lead wire (not shown) connected to each of the first coil 63 and the second coil 65 and a second coil connection terminal 56 electrically connected to the first coil connection terminal 55 at a predetermined portion of the flexible circuit board 54 formed through the opening 44.

In the present embodiment, the first coil 63 and the second coil 65 are disposed on the internal lateral surfaces of the hinge member 30 and the first magnet 64 and the second magnet 66 are disposed on the internal lateral surfaces of the body member 40 but the present invention is not limited thereto. Alternatively, the first coil 63 and the second coil 65 may be disposed on external lateral surfaces of the body member 40 and the first magnet 64 and the second magnet 66 may be disposed on internal lateral surface of the hinge member 30.

With regard to the camera module 10 with the above configuration according to the present embodiment, when an electrical signal for AF adjustment is applied to the first coil 63 from the control circuit board 53, the hinge member 30 may be rotation-vibrated by the first driver 61 based on the hinge portion 200 with respect to the body member 40 so as adjust a focal point of the lens module 20 installed in the hinge member 30, when an electrical signal for shake correction is applied to the second coil 65 from the control circuit board 53, the hinge member 30 may be rotation-vibrated by the second driver 62 based on the hinge portion 200 with respect to the body member 40 so as to correct shake of the lens module 20.

As described above, a camera module according to the present invention may be slimmed with an overall minimized thickness and may have an OIS function while correcting shake via a swing driving method by forming a hinge portion for enabling rotation-vibration motion on a lateral surface of a hinge member. It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A camera module having an optical image stabilizer (OIS) function, the camera module comprising:
an optical module comprising at least one lens and an image sensor disposed below the lens;
a hinge member for accommodating the optical module therein so as to fixedly install the optical module;
a body member disposed to surround the hinge member so as to be spaced apart from the hinge member by a predetermined interval;
a hinge portion formed at a lateral surface of the hinge member so as to connect the hinge member and the body member and formed of an elastic material so as to be rotation-vibrated; and
a first driver for rotation-vibrating the hinge member based on the hinge portion with respect to the body member.

2. The camera module according to claim 1, wherein:
the hinge member and the hinge portion are formed of an elastic material as one body such that the hinge portion protrude from a lateral surface of the hinge member; and
an end of the hinge portion protruding from the lateral surface of the hinge member is bonded to the body member.

3. The camera module according to claim 2, wherein:
the optical module comprises: a lens holder comprising the at least one lens; a base member for surrounding the lens holder so as to be spaced apart from the lens holder by a predetermined interval; an elastic member for connection between the lens holder and the base member; a sensor module comprising the image sensor and coupled to a lower portion of the base member; and a second driver for driving the lens holder with respect to the base member; and
the hinge member is bounded to the base member or is integrally formed with the base member.

4. The camera module according to claim 1, wherein the hinge portion comprises:
a first hinge portion connected to the lateral surface of the hinge member and extending in a lower direction;
a second hinge portion bent and extending frontward or backward from the first hinge portion;
a third hinge portion bent and extending from the second hinge portion in a lower direction; and
a coupler connected to the third hinge portion to extend in a lateral direction and coupled to an internal lateral surface of the body member.

5. The camera module according to claim 4, wherein:
a lateral groove is formed below the lateral surface of the hinge member; and
the first hinge portion extends in a lower direction from an upper end of the lateral groove to protrude from the lateral surface of the hinge member.

6. The camera module according to claim 4, wherein a width reduction groove for smooth rotation-vibration is formed in at least one of the first hinge portion, the second hinge portion, and the third hinge portion.

7. The camera module according to claim 4, wherein:
a first width reduction groove and a third width reduction groove for smooth rotation-vibration are formed in the first hinge portion and the third hinge portion, respectively; and
the first width reduction groove and the third width reduction groove are formed in different directions.

8. The camera module according to claim 1, wherein:
the hinge portion is disposed on one lateral surface of the hinge member; and
a support for supporting the rotation-vibrated hinge member with respect to one hinge portion is disposed at another lateral surface of the one hinge member, which faces the lateral surface.

9. The camera module according to claim 8, wherein:
the hinge member, the hinge portion , and the support are formed of an elastic material as one body such that the hinge portion and the support protrude from the two facing lateral surfaces of the hinge member;
an end portion of the hinge portion protruding from one lateral surface of the hinge member is coupled to the body member; and
an end portion of the support protruding from another lateral surface facing the one lateral surface contacts the body member.

10. The camera module according to claim 9, wherein;
a lateral groove disposed below the another lateral surface facing the one lateral surface;
the support comprises an extension portion that extends downward from an upper end of the lateral groove and a contact portion that externally protrudes from the extension portion contacts the body member; and
the body member comprises an inclination surface that the contact portion contacts.

11. A camera module having an optical image stabilizer (OIS) function, the camera module comprising:
a lens module comprising at least one lens;
a hinge member for accommodating the lens module therein so as to fixedly install the lens module;
a body member disposed to surround the hinge member so as to be spaced apart from the hinge member by a predetermined interval;
a sensor module comprising an image sensor that light incident upon the lens reaches and coupled to a lower portion of the body member;
a hinge portion formed on a lateral surface of the hinge member to connect the hinge member and the body member and formed of an elastic member so as to be rotation-vibrated; and
a driver for rotation-vibrating the hinge member based on the hinge portion with respect to the body member.

12. The camera module according to claim 11, wherein:
the hinge portion is disposed on one lateral surface of the hinge member; and
a support for supporting the rotation-vibrated hinge member with respect to one hinge portion is disposed at another lateral surface of the one hinge member, which faces the lateral surface.

13. The camera module according to claim 11, wherein the driver comprises:
a first driver for auto focus (AF) adjustment comprising a first coil and a first magnet that are respectively disposed on an external lateral surface of the hinge member and an internal lateral surface of the body member so as to face each other; and
a second driver for shake correction comprising a second coil and a second magnet that are respectively disposed on an external lateral surface of the hinge member and an internal lateral surface of the body member so as to face each other separately from the first driver.

14. The camera module according to claim 1, wherein the hinge portion is configured in the form of a single axis protruding from a lateral surface of the hinge member.

15. The camera module according to claim 14, wherein:
the hinge member and the hinge portion are formed of an elastic material as one body such that the hinge portion protrude from a lateral surface of the hinge member; and
an end of the hinge portion protruding from the lateral surface of the hinge member is bonded to the body member.
